(19) United States
(12) Patent Application Publication
(10) Pub. No.: US 2024/0212074 A1
(43) Pub. Date: Jun. 27, 2024

(54) INFORMATION PROCESSING METHOD AND STORAGE MEDIUM

(71) Applicant: TOYOTA JIDOSHA KABUSHIKI KAISHA, Toyota-shi (JP)

(72) Inventors: Ibuki SHIMADA, Miyoshi-shi (JP); Hiroki Takeishi, Tokyo (JP); Koki Moriya, Nagakute-shi (JP); Koji Ueda, Hunabashi-shi (JP); Ai Miyata, Osaka (JP)

(73) Assignee: TOYOTA JIDOSHA KABUSHIKI KAISHA, Toyota-shi (JP)

(21) Appl. No.: 18/501,480

(22) Filed: Nov. 3, 2023

(30) Foreign Application Priority Data
Dec. 27, 2022 (JP) 2022-210403

(51) Int. Cl. G06Q 50/06; B60L 53/57; B60L 53/66; G06Q 30/0283; G06Q 40/04

(52) U.S. Cl. CPC G06Q 50/06; B60L 53/57; B60L 53/665; G06Q 30/0284; G06Q 40/04

(57) ABSTRACT

An information processing method by an information processing apparatus includes: receiving, from a power buying user terminal, a purchase request for electric power to be charged in a purchased power user vehicle; receiving, from the sold power user terminal, a selling request for electric power; determining, from the purchase request and the selling request, da selling power user and a buying power user as parties to a power transaction; determining a power transaction matter indicating a party, a charging position, and a charging amount; and notifying the purchasing power user terminal and the selling power user terminal of a power transaction matter.

### CROSS-REFERENCE TO RELATED APPLICATION

This application claims priority to Japanese Patent Application No. 2022-210403 filed on Dec. 27, 2022, incorporated herein by reference in its entirety.

### BACKGROUND

### 1. Technical Field

The present disclosure relates to an information processing method and a storage medium.

### 2. Description of Related Art

Hitherto, there is known a service in which a power supply vehicle rushes to a host vehicle and supplies electric power to the host vehicle when a power supply request to the host vehicle is made on an application (see, for example, NIO LIMITED, “NIO Power”, [online], 2022, [Searched on Dec. 14, 2022], Internet <URL: https://www.nio.com/nio-power>).

### SUMMARY

In the above background art, the revenue from electric power selling is not taken into consideration.

In view of such circumstances, an object of the present disclosure is to enable a user who sells electric power to obtain electric power sales revenue.

An information processing method according to an embodiment of the present disclosure is an information processing method to be performed by an information processing device, and includes: receiving a power buying request for electric power charged in a power buying user vehicle from a power buying user terminal; receiving a power selling request for electric power from a power selling user terminal; determining a power selling user and a power buying user as parties of a power transaction based on the power buying request and the power selling request, and then determining a power transaction matter indicating the parties, a charging position, and a charging amount; and notifying the power transaction matter to the power buying user terminal and the power selling user terminal.

A storage medium according to another embodiment of the present disclosure stores a program that causes an information processing device and a communicable computer to execute operations including: receiving an input of a power buying request indicating a desired charging position and a desired charging amount from a power buying user; transmitting the power buying request to the information processing device; and displaying, on a display unit, a power transaction matter received from the information processing device, the power transaction matter being a power transaction matter determined in accordance with the power buying request and indicating parties of a power transaction, a charging position, and a charging amount.

A storage medium according to another embodiment of the present disclosure stores a program that causes an information processing device and a communicable computer to execute operations including: receiving an input of a power selling request indicating a desired charging position and a desired charging amount from a power selling user; transmitting the power selling request to the information processing device; and displaying, on a display unit, a power transaction matter received from the information processing device, the power transaction matter being a power transaction matter determined in accordance with the power selling request and indicating parties of a power transaction, a charging position, and a charging amount.

According to the embodiment of the present disclosure, it is possible to enable a user who sells electric power to obtain electric power sales revenue.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram illustrating a configuration of an information processing device;

FIG. 3 is a block diagram illustrating a configuration of each of a power selling user terminal and a power buying user terminal;

FIG. 4 is a sequence diagram illustrating an operation of the information processing system;

FIG. 5 is a diagram showing a data-structure of a transaction DB (database); and

FIG. 6 is a diagram illustrating an exemplary presented to a power selling user terminal.

### DETAILED DESCRIPTION OF EMBODIMENTS

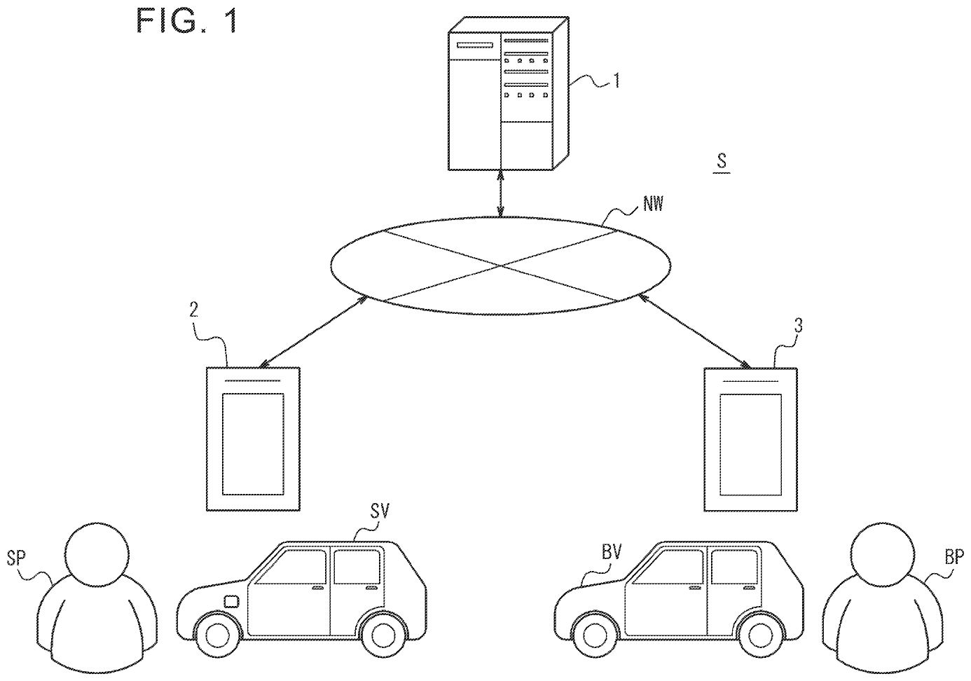

FIG. 1 is a schematic diagram of an information processing system S according to the present embodiment. The information processing system S includes an information processing device 1 capable of communicating with each other via a network NW, a power selling user terminal 2, and a power buying user terminal 3. The network NW includes, for example, a mobile communication network, a fixed communication network, or the Internet.

The power selling user terminal 2 is operated by a power selling user SP. The power selling user SP drives the power selling user vehicle SV or rides on the power selling user vehicle SV. The power buying user terminal 3 is operated by a power buying user BP. The power buying user BP drives the power buying user vehicle BV or rides on the power buying user vehicle BV. One of the power selling user vehicle SV and the power selling user vehicle SV moves to the other of the power selling user vehicle SV and the power selling user vehicle SV. The power selling user vehicle SV supplies electric power from the power selling user vehicle SV to the power buying user vehicle BV. Here, each of the power selling user vehicle SV and the power buying user vehicle BV is a battery electric vehicle including a battery, but is not limited thereto. Alternatively, the electric power may be supplied to the power buying user vehicle BV from a charging device managed at a home or the like by the power selling user SP.

In FIG. 1, the information processing device 1, the power selling user terminal 2, and the power buying user terminal 3 are illustrated one by one for convenience of explanation. However, the number of the information processing device 1, the power selling user terminal 2, and the power buying user terminal 3 is not limited to this. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

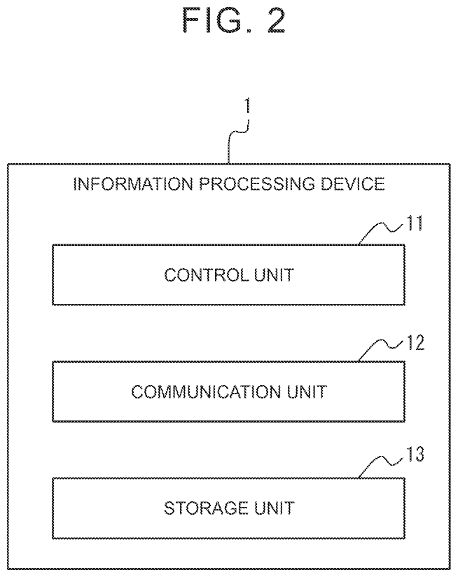

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including Central Processing Unit (CPU) or Micro Processing Unit (MPU). The control unit 11 may include one or more dedicated processors specialized for a specific process. The control unit 11 may include one or more dedicated circuits instead of the processor. The dedicated circuit may be, for example, a field-programmable gate array (FPGA) or an application-specific integrated circuit (ASIC). The control unit 11 may include an electronic control unit (ECU). The control unit 11 transmits and receives arbitrary information via the communication unit 12.

The communication unit 12 includes a communication module conforming to one or more wired or wireless local area network (LAN) standards for connecting to the network NW. The communication unit 12 may include modules corresponding to one or more mobile communication standards including Long Term Evolution (LTE), the fourth generation (4G), or the fifth generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1. The storage unit 13 includes a transaction DB.

The power selling user terminal 2 is, for example, a mobile terminal such as a mobile phone, a smartphone, a wearable device, or a tablet. Alternatively, the power selling user terminal 2 may be a general-purpose device such as a PC or a dedicated device. PC is an abbreviation for personal computer.

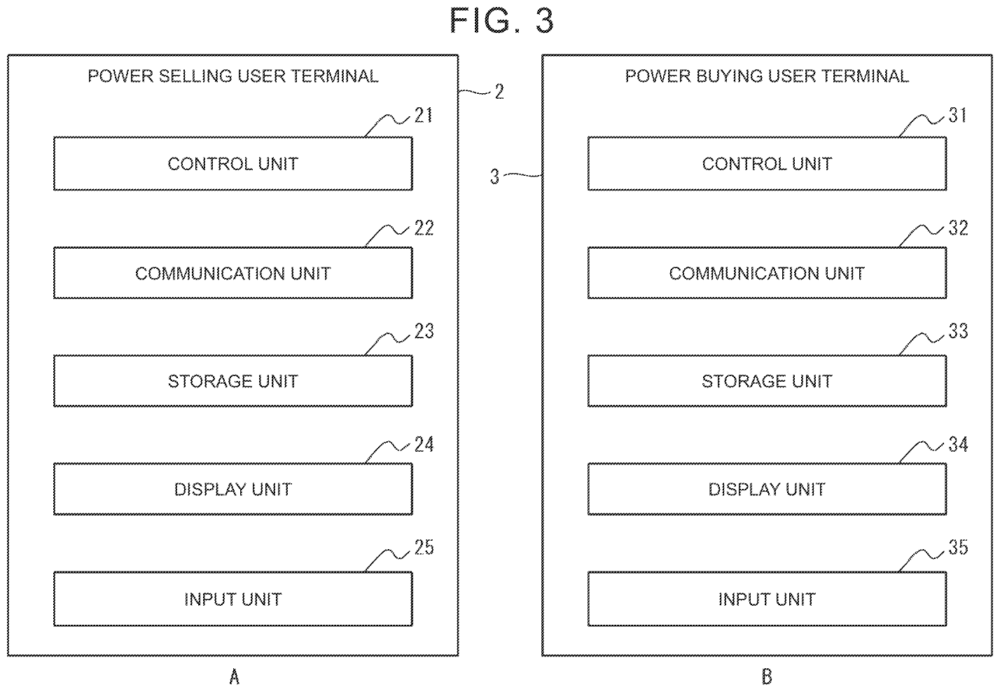

In A of FIG. 3, the internal configuration of the power selling user terminal 2 will be described in detail.

The power selling user terminal 2 includes a control unit 21, a communication unit 22, a storage unit 23, a display unit 24, and an input unit 25. The components of the power selling user terminal 2 are communicably connected to each other via, for example, a dedicated line.

The hardware configuration of the control unit 21, the communication unit 22, and the storage unit 23 of the power selling user terminal 2 may be the same as the hardware configuration of the control unit 11, the communication unit 12, and the storage unit 13 of the information processing device 1. The description here is omitted.

The display unit 24 is, for example, a display. The display is, for example, an LCD or an organic EL display. LCD is an abbreviation for liquid crystal display. The term “EL” is an abbreviation for “electroluminescence”. Instead of being provided in the power selling user terminal 2, the display unit 24 may be connected to the power selling user terminal 2 as an external output device. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrally provided with a display, or a microphone. The input unit 25 receives an operation of inputting information used for the operation of the power selling user terminal 2. Instead of being provided in the power selling user terminal 2, the input unit 25 may be connected to the power selling user terminal 2 as an external input device. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

In B of FIG. 3, the internal configuration of the power buying user terminal 3 will be described in detail. The power buying user terminal 3 includes a control unit 31, a communication unit 32, a storage unit 33, a display unit 34, and an input unit 35. The respective components of the power buying user terminal 3 are communicably connected to each other via, for example, a dedicated line.

The hardware configuration of the control unit 31, the communication unit 32, the storage unit 33, the display unit 34, and the input unit 35 of the power buying user terminal 3 may be the same as the hardware configuration of the control unit 21, the communication unit 22, the storage unit 23, the display unit 24, and the input unit 25 of the power selling user terminal 2. The description here is omitted.

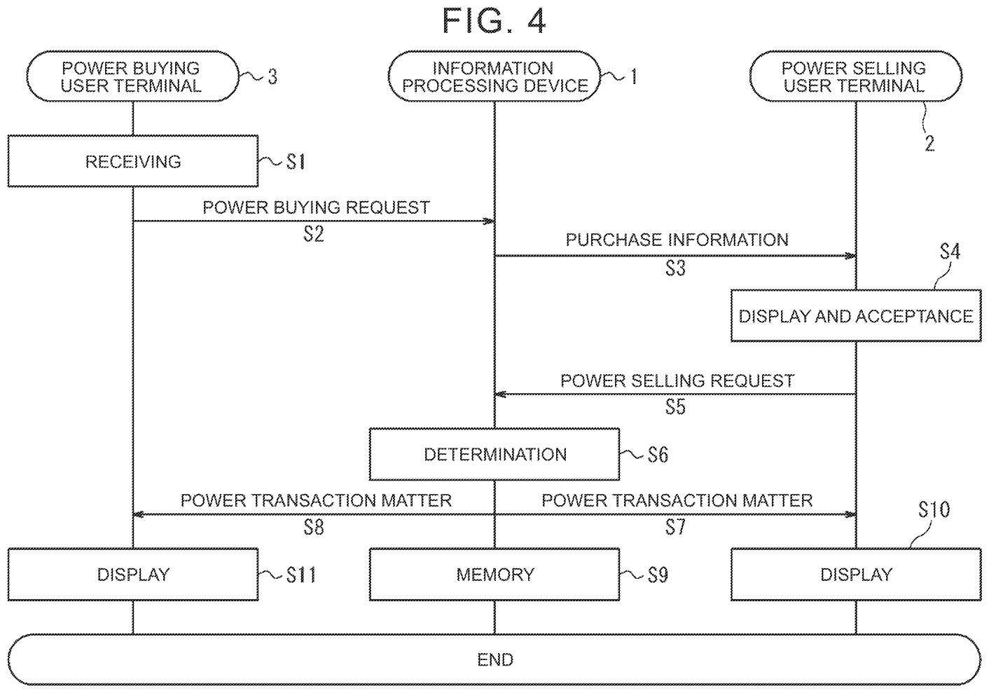

Hereinafter, an information processing method by the information processing system S will be described in detail with reference to FIG. 4. Here, as an example, a scene in which a power buying user BP makes a power buying request to purchase electric power to be charged in a power buying user vehicle BV will be described.

In S1, the control unit 31 of the power buying user terminal 3 receives an input of a power buying request from the power buying user BP via the input unit 35. For example, the power buying request indicates the following information that is specified or input by the power buying user BP.
Desired charging volume (optional)
Desired charging position
Desired charging time (optional)
Desired charging amount

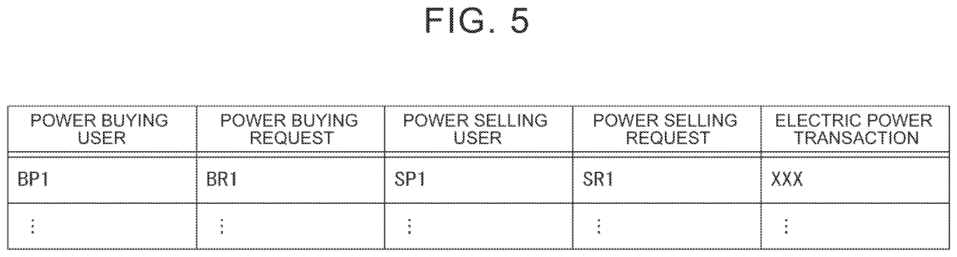

In S2, the control unit 31 transmits a power buying request to the information processing device 1. Upon receiving the power buying request, the control unit 11 of the information processing device 1 stores the power buying request in the transaction DB in association with the power buying user BP as illustrated in FIG. 5.

In S3 of FIG. 4, the control unit 11 of the information processing device 1 transmits the power purchase information to one or more power selling user terminals including the power selling user terminal 2. The purchase information includes the following information.
Desired charging volume (optional)
Desired charging position
Desired charging time (optional)
Desired charge amount
Power buying user BP

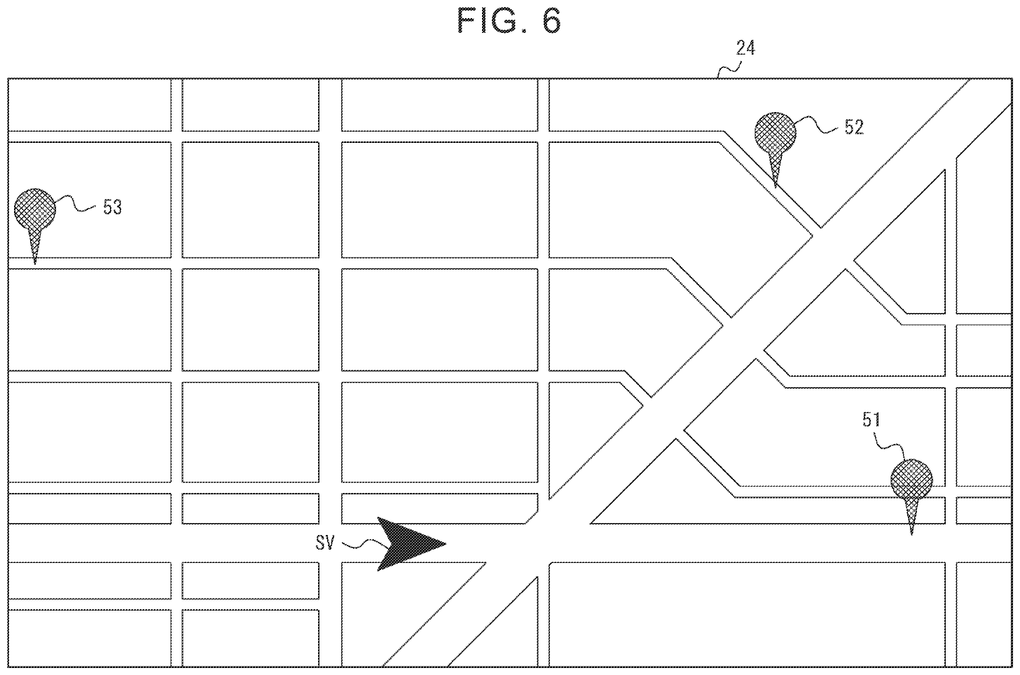

Upon receiving the power purchase information, the control unit 21 of the power selling user terminal 2 displays the power purchase information on the display unit 24 in S4 as shown in FIG. 6. Here, as an example, the desired charging position included in the power buying request of the power buying user terminal 3 is selectably shown as the position 51. As an additional instance, any mark, such as a “charge HELP” mark, may be displayed in association with position 51. A desired charging position indicated in a power buying request received from another power buying user terminal may be selectably indicated as position 52 and position 53. The present position of the power selling user vehicle SV on which the power selling user SP rides is displayed on the display unit 24. Alternatively, when electric power is sold from the charging device managed by the power selling user SP to the power buying user vehicle BV, the current position of the charging device may be indicated on the display unit 24 instead of the current position of the power selling user vehicle SV.

The power selling user SP visually recognizes the display unit 24. The power selling user SP selects any one of the positions 51 to 53 to determine at which position the power selling user SP is to be sold. The control unit 21 of the power selling user terminal 2 receives an input of an electric power selling request indicating a selection for any of the positions 51 to 53 via the input unit 25.

In S5, the power selling user terminal 2 transmits a power selling request to the information processing device 1. For convenience of explanation, a case where the position 51 is selected will be described.

In S6, the control unit 11 of the information processing device 1 determines the position 51 selected in the power selling user terminal 2 as the charge position.

In S7 and S8, the control unit 11 determines a power transaction matter indicating the following information, and notifies the power selling user terminal 2 and the power buying user terminal 3 of the power transaction matter.
Charging volume
Charging position
Charging time
Charging amount
Party to the power transaction (i.e., a power buying user BP and a power selling user SP)
   Charging volume, charging position, charging time, and each of the charging amount may be the same as each of the desired charging volume, the desired charging position, the desired charging time, and the desired charging amount. The order of executing S7 and S8 is arbitrary.

In S9, as illustrated in FIG. 5, the control unit 11 stores the power buying user BP, the power buying request BR, the power selling user SP, the power selling request SR, and the power transaction matter in the storage unit 13 in association with each other.

Each of the display unit 24 of the power selling user terminal 2 and the display unit 34 of the power buying user terminal 3 displays electric power transaction matter in S10 and S11. The order of executing S9, S10, and S11 is arbitrary. At least one of the power selling user vehicle SV and the power buying user vehicle BV moves to the determined charging position. The travel by the power selling user vehicle SV may be referred to as a business trip. The power selling user vehicle SV supplies electric power to the power buying user vehicle BV at the charging position.

The method of paying the charge amount is arbitrary. For example, the control unit 11 may store, in the storage unit 13, the retained balance of the money used for the electric power transaction in association with each of the power selling user SP and the power buying user BP. The holdings may be refilled by any means of payment, such as credit card payment. The holding balance may be withdrawn by any means of payment. The control unit 11 increases the holding balance of the power selling user SP by the charge amount after the electric power selling from the power selling user SP to the power buying user BP is performed. The control unit 11 reduces the holding balance of the power buying user BP by the charge amount.

Additionally or alternatively, the control unit 11 may allow the power selling user SP to pay at least a portion of the charge amount from the stored balance stored in association with the user when the power selling user SP buys power at a later time. The charge amount is discounted by the amount paid from the holding balance.

As an additional example or as an alternative, the control unit 11 may settle the holding balance every predetermined period of time (for example, one month). For example, the control unit 11 calculates a difference by subtracting the amount of expenditure paid by the same user by the purchased power in the same period from the amount of revenue obtained by the user by the selling power in the predetermined period. In this way, the control unit 11 may offset the amount of revenue in the electric power selling and the amount of expenditure in the electric power purchasing. The control unit 11 pays the calculated difference to the user by transfer or the like.

In the above-described embodiment, the power buying user terminal 3 transmits the power buying request, and the power selling user terminal 2 responding to the power buying request transmits the power selling request. Alternatively, the power selling user terminal 2 may transmit the power selling request, and the power buying user terminal 3 responding to the power selling request may transmit the power buying request. The power selling request includes, for example, the following information.
Desired charging volume (optional)
Desired charging position
Desired charging time (optional)
Desired charging amount
   In an alternative, the power buying user BP may view one or more power selling requests on a display as shown in FIG. 6 to determine which of the one or more power selling requests to respond to.

Since the sequence diagrams of the alternative examples are similar to the sequence diagrams of the above-described embodiments, redundant descriptions are omitted.

As described above, according to the present embodiment, the operation of the control unit 11 of the information processing device 1 includes: receiving, from the power buying user terminal 3, a power buying request for electric power to be charged to the power buying user vehicle BV; receiving, from the power selling user terminal 2, a power selling request for electric power of the power selling user SP; determining, from the buying request and the selling request, the power selling user SP and the power buying user BP as parties to the electric power transaction; determining the electric power transaction matters indicating the charging position and the charging amount; and notifying the power buying user terminal 3 and the power selling user terminal 2 of the electric power transaction matters. With this configuration, the information processing device 1 enables the power selling user SP that sells electric power to obtain the charge amount as the electric power selling revenue. For example, the information processing device 1 enables the power selling user SP to sell electric power at the highest possible amount, and to make profits by selling electric power.

Further, according to the present embodiment, each of the charging position and the charging amount is designated in the power selling request or the power buying request. With this configuration, the information processing device 1 enables the power selling user SP or the power buying user BP to designate each of the charging position and the charging amount.

Further, according to the present embodiment, the electric power transaction item further indicates the charge amount or the charging time specified in the electric power selling request or the electric power buying request. With this configuration, the information processing device 1 enables the power selling user SP or the power buying user BP to specify the charge quantity or the charge time.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above-described embodiment, a program that executes all or a part of the functions or processes of the information processing device 1, the power selling user terminal 2, and the power buying user terminal 3 can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a Digital Versatile Disc (DVD) or a Compact Disc Read Only Memory (CD-ROM) in which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method to be performed by an information processing device, the information processing method comprising:
receiving a power buying request for electric power charged in a power buying user vehicle from a power buying user terminal;
receiving a power selling request for electric power from a power selling user terminal;
determining a power selling user and a power buying user as parties of a power transaction based on the power buying request and the power selling request, and then determining a power transaction matter indicating the parties, a charging position, and a charging amount; and
notifying the power transaction matter to the power buying user terminal and the power selling user terminal.

2. The information processing method according to claim 1, wherein each of the charging position and the charging amount is specified in the power selling request or the power buying request.

3. The information processing method according to claim 1, wherein the power transaction matter further indicates a charging volume or a charging time specified in the power selling request or the power buying request.

4. A non-transitory storage medium storing a program that causes an information processing device and a communicable computer to execute operations comprising:
receiving an input of a power buying request indicating a desired charging position and a desired charging amount from a power buying user;
transmitting the power buying request to the information processing device; and
displaying, on a display unit, a power transaction matter received from the information processing device, the power transaction matter being a power transaction matter determined in accordance with the power buying request and indicating parties of a power transaction, a charging position, and a charging amount.

5. A non-transitory storage medium storing a program that causes an information processing device and a communicable computer to execute operations comprising:
receiving an input of a power selling request indicating a desired charging position and a desired charging amount from a power selling user;
transmitting the power selling request to the information processing device; and
displaying, on a display unit, a power transaction matter received from the information processing device, the power transaction matter being a power transaction matter determined in accordance with the power selling request and indicating parties of a power transaction, a charging position, and a charging amount.
